(19) United States
(12) Patent Application Publication
(10) Pub. No.: US 2002/0029343 A1
(43) Pub. Date: Mar. 7, 2002

(54) Smart card access management system, sharing method, and storage medium

(75) Inventor: Takayoshi Kurita, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 09/809,736

(22) Filed: Mar. 14, 2001

(30) Foreign Application Priority Data
Sep. 5, 2000 (JP) 2000-269096

(51) Int. Cl. H04L 9/00; H04K 1/00

(52) U.S. Cl. 713/185; 713/172

(57) ABSTRACT

A system and a method for managing access to a smart card by allowing authentication for each application (process) in response to access requests from a plurality of applications and processes. When an application containing a plurality of access processes for a smart card issues an access request for the smart card, the application issues an exclusive access request to an exclusion control mechanism, and issues the access request to an access control mechanism if the application is allowed exclusive access. If the application has not been authenticated, the access control mechanism prompts the application to input a PIN. If the application has already been authenticated, the access control mechanism permits the application to access the smart card. The application issues an exclusive access request/cancellation in an accessing process unit. Although a plurality of applications share a smart card, each application can be authenticated individually. The overhead from an authenticating process can be reduced.

### BACKGROUND OF THE INVENTION

1. Field of the Invention

The present invention relates to the access management of a smart card when the data on the smart card is shared by a plurality of processes.

2. Description of Related Art

Since a smart card can store a large volume of data as compared with a conventional magnetic card, it has been studied and put to practical use in various fields.

Furthermore, a smart card contains memory and a CPU to access data in the memory through the CPU. Therefore, the CPU performs an authenticating process when data is accessed, thereby realizing higher security than the conventional magnetic card. This advantageously marks a smart card.

A smart card has a security function of a PIN (personal identification number). That is, a matching check is performed on a PIN. Only if it is authenticated, the confidential information in a card can be accessed. The authentication system using a PIN belongs to a password input system. A user of a smart card inputs, for example, a password as a PIN which is compared in the card with the password stored in the card. It they match each other, the user is permitted to access the data in the card.

A smart card can be accessed through a logical channel of the smart card, and an authentication request is issued to the logical channel. The smart card holds the status about the security such as an authentication status by a PIN, etc. for each logical channel.

FIG. 1 shows the logical configuration in a smart card from the viewpoint of an application.

In the smart card, data is managed in the configuration of a tree structure in which a DF (dedicated file) is provided by each an application unit, etc., below the highest-order DIR. Each DF stores an EF (elementary file) containing actual data. When data is accessed from a smart card, an application first transmits location information about the position of the data to be accessed, moves the access position to the target EF, and reads from or writes to the EF. In addition, each channel holds the current access position as status information.

The method of using a smart card simultaneously by a plurality of applications has been studied. For example, when a PKI (public key infrastructure) system based on the public key encryption system is designed, and a plurality of applications are operated in a computer in the PKI system, a smart card can be used by an application in checking security using a digital signature, etc.

In this case, a plurality of applications in a computer to which the smart card is connected share the smart card. Since one smart card can have at most two logical channels, it is necessary for a plurality of applications to share one logical channel when the plurality of applications is permitted to access the same card. For simple explanation, the following descriptions in this specification are based on that one application is configured by one process, and a term ‘application’ is assumed to be synonymous with a ‘process’. Normally, one application is configured by one process. However, although it is configured by a plurality of processes, the following descriptions are true with either case if an application is replaced with a process.

In the current smart card security system, if one application performs a PIN authentication process on a logical channel, and is permitted to access a card, then not only the authenticated application, but also other applications can access the card through the logical channel until the authentication is canceled.

From the viewpoint of security, sharing the same information on one card among a plurality of applications can be secured at a higher level when an authenticating process is performed using a PIN for each application. However, in controlling access to a smart card, an authenticating process is performed for each logical channel and an authentication status (whether or not permission to access a card is allowed) is held in each logical channel when a plurality of applications share one logical channel. Therefore, if one application obtains permission to access a card through an authentication process using a PIN, then another application can access the card through the logical channel without authentication by a PIN.

Furthermore, as described above, when each application accesses data in a card, it first transmits the location information to a logical channel, moves the access position, and then writes or reads the data. However, when a plurality of applications share a logical channel, it is difficult to confirm the current access position for each application.

### SUMMARY OF THE INVENTION

To solve the above mentioned problems, the present invention aims at providing a smart card access management system and method for allowing permission for each application (process) by centrally managing the authentication status of a smart card in response to access from a plurality of applications (processes). It also aims at providing an access management system and method for realizing authentication for each application (process) without increasing the overhead by an authenticating process.

The smart card access management system according to the present invention is based on the management of access to a smart card by a plurality of applications, and includes an exclusion control unit and an access control unit.

In response to an exclusive access request for a smart card from an application, the exclusion control unit allows the application the exclusive access to the smart card if the smart card has a logical channel not exclusively accessed by another application. Furthermore, in response to an exclusive access request for a smart card from an application, the exclusion control unit queues the application requesting the exclusive access to the smart card if the smart card has no logical channel which is not exclusively accessed by another application.

In response to an access request for the smart card from an application allowed the exclusive access, the access control unit permits the application allowed the exclusive access to access the smart card when the application allowed the exclusive access has already been authenticated for the smart card. In response to the access request, the access control unit requests the application to input a PIN when the application allowed the exclusive access has not been authenticated for the smart card. A smart card is authenticated for each application through the access control unit, and the access control unit grasps the authentication between each application and the smart card.

According to the present invention, since the exclusion control unit controls the exclusive access to a smart card, an authenticating process can be performed for each application although a plurality of applications share a smart card.

Furthermore, since the access control unit determines whether or not an application issuing each access request has been authenticated, permission to access a card is allowed without performing an authenticating process if it has already been authenticated, thereby reducing the times of authenticating processes.

### BRIEF DESCRIPTION OF THE DRAWINGS

FIG. 1 shows the logical configuration inside a smart card;

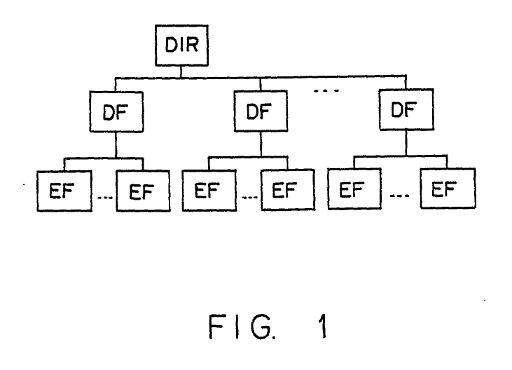

FIG. 2 shows the configuration when an exclusion control mechanism is provided to allow exclusive access to a smart card;

FIG. 3 shows a process of each application accessing a smart card when an exclusion control mechanism is provided;

FIG. 4 shows the configuration provided with an exclusion control mechanism and an access control mechanism;

FIG. 5 shows an example of the configuration of an authentication status management table;

FIG. 6 is a flowchart of the process of an application, an exclusion control mechanism, and an access control mechanism when an application accesses a smart card;

FIG. 7 shows a process of each application accessing a smart card when an exclusion control mechanism and an access control mechanism are provided;

FIG. 8 is a flowchart of the process of an application accessing a smart card;

FIG. 9 is a flowchart of the process of an exclusion control mechanism in response to an exclusive access request from an application;

FIG. 10 is a flowchart of the process of an exclusion control mechanism in response to an exclusion cancellation notification from an application;

FIG. 11 is a flowchart of the process of an access control mechanism in response to an access start declaration from an application to a smart card;

FIG. 12 is a flowchart of the process of an access control mechanism in response to an access request from an application to a smart card;

FIG. 13 shows the configuration of the system using a smart card according to an embodiment of the present invention;

FIG. 14 shows a system environment of an information processing device; and

FIG. 15 shows an example of a storage medium.

### DESCRIPTION OF THE PREFERRED EMBODIMENT

A preferred embodiment of the present invention is described below by referring to the attached drawings.

To authenticate each application, it is necessary to allow exclusive access to a smart card (a logical channel when a smart card has a plurality of logical channels), the application occupies the card (or the logical channel) while an authenticated application is using the smart card, and access from other applications has to be suppressed. For simple explanation, it is assumed in the embodiment below that each smart card is assigned one logical channel. When a smart card is provided with a plurality of logical channels, the exclusion control described below is performed in a logical channel unit.

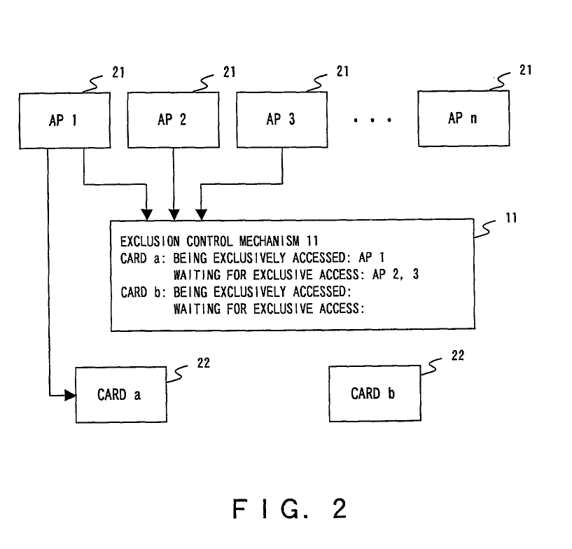

FIG. 2 shows the case in which an exclusion control mechanism is provided to allow an application exclusive access to a smart card.

In FIG. 2, an exclusion control mechanism 11 is provided between a plurality of applications 21 and a smart card 22, each application 21 issues an exclusive access request to the exclusion control mechanism 11 when it requests to access the smart card 22, and an application 21 which has successfully been allowed exclusive access can exclusively access the smart card 22. The exclusion control mechanism 11 shown in FIG. 2 manages the exclusive access to two cards, that is, a card a and a card b. Three applications 21, that is, an AP 1, an AP 2, and an AP 3, issue requests to access the card a, and the exclusion control mechanism 11 allows the AP 1 exclusive access, and keeps other APs 2 and 3 waiting until the card a is released. The AP 1 allowed the exclusive access reads/writes data after authenticating the logical channel of the card a using a PIN. On the other hand, other applications 21 cannot access the card a. When the AP 1 releases the card A after completing the process, then the waiting AP 2 obtains exclusive access, authenticates the card a using a PIN, and accesses the data inside. Thus, by providing the exclusion control mechanism 11, only one application can access a smart card, and the authenticating process can be performed on each application 21.

In the system with the configuration shown in FIG. 2, the smart card 22 is occupied by one application 21 while the application 21 is using the smart card 22. Therefore, other applications 21 enters a wait state until the exclusive access of the application 21 is canceled and the smart card 22 is released. As a result, in this system, a plurality of applications cannot efficiently perform parallel processes. And the applications in the wait state seem to be hung-up, because the applications have to stop their processes for a long time, so this system may not be so easy to handle.

To avoid this inconvenience, the application 21 can sequentially release the occupied smart card 22 upon completion of the accessing process on the smart card 22. In this system, when the application 21 performs plural times the accessing process on the smart card 22, the application 21 requests the exclusion control mechanism 11 for exclusive access to the smart card 22 and release of it, that is, the exclusive access is delimited in pieces.

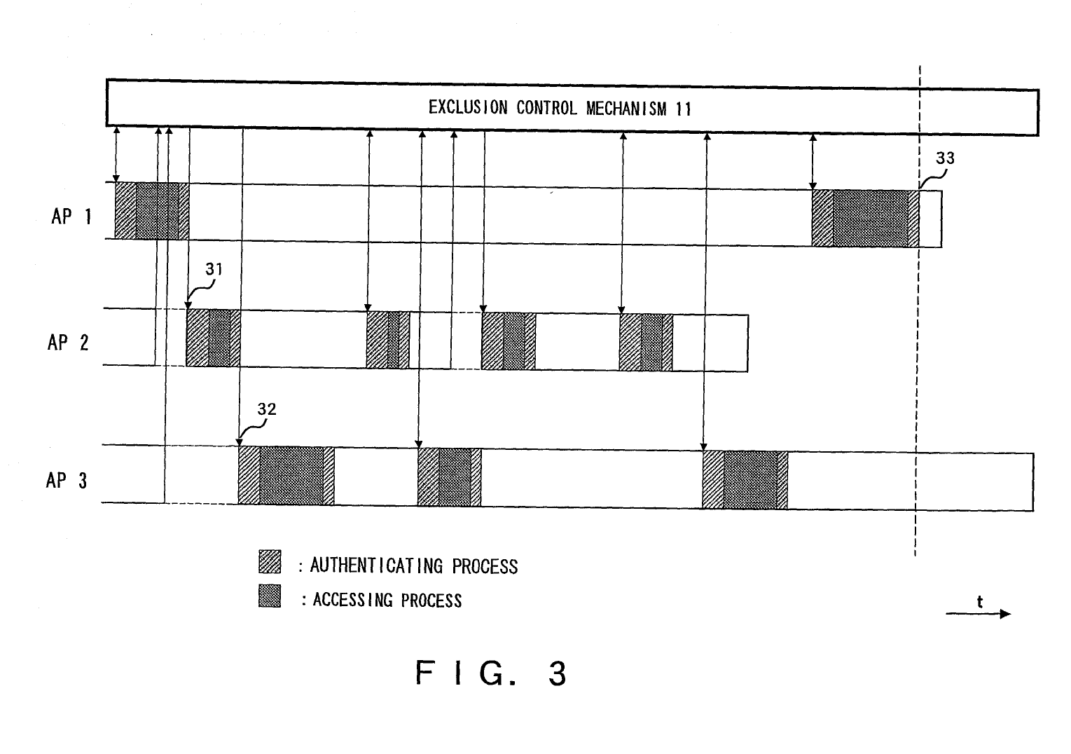

FIG. 3 shows an example of the exclusive access to and release of a smart card by each application.

FIG. 3 shows an example of the process of the three applications 21, that is, the APs 1, 2, and 3 as in the case shown in FIG. 2, accessing a smart card when they issue requests to access the card a. In FIG. 3, the arrow ↑ to the exclusion control mechanism 11 indicates a request from each application 21 to the exclusion control mechanism 11 to obtain exclusive access, and the arrow ↓ from the exclusion control mechanism 11 indicates an exclusive access notification from the exclusion control mechanism 11 to each application 21. The hatched portion indicates an authenticating process using a PIN, and a net portion indicates the process of accessing the smart card 22.

If the application 21 allowed exclusive access does not cancel the exclusive access and release the smart card 22 until the entire process is completed, the AP 2 is set in the wait state from the position 31 shown in FIG. 3 at which the AP 2 issued the exclusive access request to the exclusion control mechanism 11 to the position 33 at which the AP 1 already allowed the exclusive access to the card a completes the process. The AP 3 is also set in the wait state from the position 32 to the position at which the AP 2 completes the process. However, if the application 21 shown in FIG. 3 delimits the exclusive access in pieces for each accessing process, another application 21 can access the card a while the exclusive access is being canceled, thereby shortening the waiting time in which applications are kept waiting by the exclusive access, and improving the parallelism of the processes.

Thus, by frequently switching the exclusion control, the waiting time of each application can be shortened and the parallelism of the processes can be improved. However, as shown by the hatched portion shown in FIG. 3, it is necessary that each application has to set and release the authentication status each time control is switched, thereby increasing overhead. Furthermore, since a PIN is transmitted to request again authentication permission, each application 21 continues holding the PIN, thereby causing the problem with security. If a user inputs a password in each authenticating process to avoid this problem, the authenticating process furthermore increases the overhead.

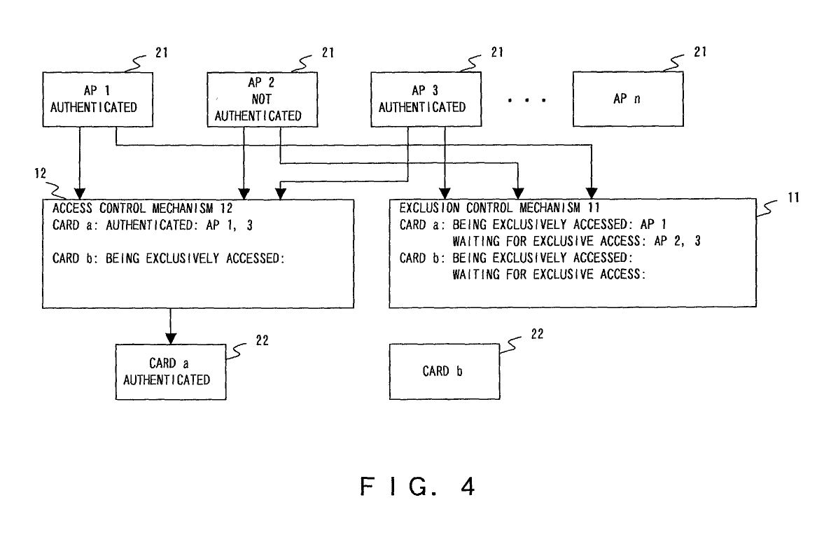

FIG. 4 shows the configuration with the above mentioned problem taken into account.

In the configuration shown in FIG. 4, an access control mechanism 12 is provided in addition to the exclusion control mechanism 11 between the application 21 and the smart card 22. While the access control mechanism 12 is centrally managing the authentication of each application 21 for the smart card 22, the exclusion control mechanism 11 allows the application 21 exclusive access to the smart card 22.

When each application 21 requests access to the smart card 22, it first requests the exclusion control mechanism 11 to allow the application 21 exclusive access, and then requests the access control mechanism 12 to authenticate the smart card 22 when it is allowed the exclusive access. When the authenticating process is successfully performed, the application accesses the data in the smart card 22.

The access control mechanism 12 has an authentication status management table. Using the authentication status management table, the access control mechanism 12 manages the authentication status between each application and the smart card 22 after the application 21 declares the start of authentication of the smart card 22 until it issues an authentication release notification.

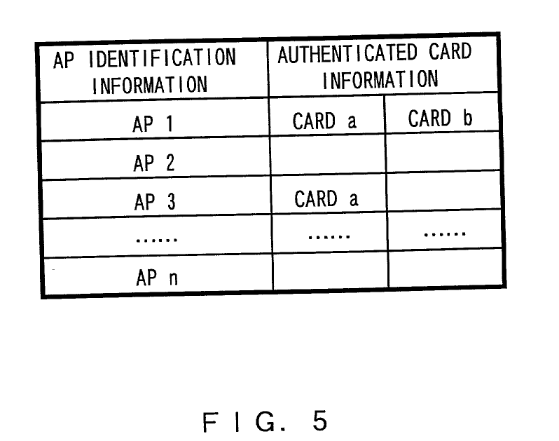

FIG. 5 shows an example of the configuration of the authentication status management table.

The authentication status management table is used by the exclusion control mechanism 11 managing the current authentication state of each application 21 for the smart card 22, and stores application identification information associated with authenticated card information. The application identification information stores unique identifier for identification of each application 21. The identifier cannot be operated by a common application. For example, it can be a process ID which is managed by a kernel, and is assigned to each process when the process is generated. Otherwise, an identifier can be sequentially generated by the access control mechanism 12 for the application 21 which requests access to a smart card.

FIG. 5 shows an example of an authentication status management table when the authentication status of each application 21 for the two smart cards 22, that is, the cards a and b. The authentication status management table stores the cards for which the application 21 is authenticated as the authenticated card information for each application. The blank portion for the authenticated card information indicates that there are no smart cards authenticated for the application. In FIG. 5, the AP 1 has been authenticated for the cards a and b, but the APs 2 and n have not been authenticated for any card, and the AP 3 has been authenticated only for the card a.

Each application 21 is authenticated for the smart card 22, and accesses the smart card 22 through the access control mechanism 12. When the application 21 issues an access request to the smart card 22, the access control mechanism 12 checks by referring to the authentication status management table whether or not the application 21 has already been authenticated for the smart card 22 to which the application 21 requests to access. If it has not been authenticated yet, the access control mechanism 12 rejects the request from the application 21, and requests the application 21 to input a PIN to perform an authenticating process for the smart card 22. If the application 21 has already been authenticated, the application 21, then the application 21 has already allowed the authentication permission for the application 21, and the access to the application 21 is permitted and executed.

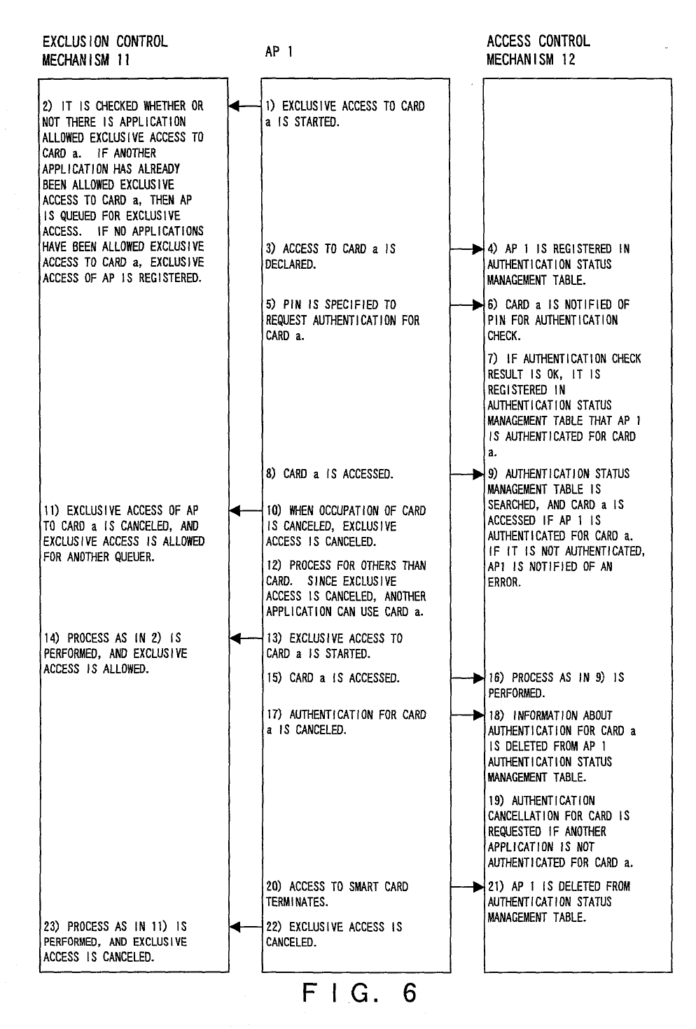

FIG. 6 is a flowchart of the process of the application 21, the exclusion control mechanism 11, and the access control mechanism 12 when the application 21 accesses the smart card 22. FIG. 6 shows an example of the AP 1 accessing the card a, and 1) through 23) in the descriptions correspond to the numbers shown in FIG. 6.

1) The AP 1 requests the exclusion control mechanism 11 to allow exclusive access to the card a to start the exclusive access.

2) Upon receipt of the request from the AP 1, the exclusion control mechanism 11 checks whether or not there is an application allowed exclusive access to the card a. If another application has already been allowed the exclusive access to the card a, then the AP 1 is queued for exclusive access. If no applications have been allowed the exclusive access to the card a, the AP 1 receives an exclusive access notification.

3) The AP 1 declares the start of accessing the card a on the access control mechanism 12.

4) In response to the access start declaration, the access control mechanism 12 registers the AP 1 in the authentication status management table. Then, it requests the AP 1 to input a PIN. If the AP 1 has also declared the start of accessing the card b, the AP has already been registered in the authentication status management table. Therefore, it is not necessary to register it again in the authentication status management table by declaring the start of accessing the card a.

5) The AP 1 prompts the user to input a password, specifies a PIN from the input of the user, and requests the authentication for the card a.

6) The exclusion control mechanism 11 notifies the card a of the PIN, and has the card a make an authentication check.

7) The access control mechanism 12 registers in the authentication status management table that the AP 1 has been authenticated for the card a if the authentication check made by the card a indicates successful authentication.

8) The AP 1 requests the access control mechanism 12 to read or write data from or to the card a.

9) Upon receipt of the read/write request from the AP 1, the authentication status management table is searched. If the AP 1 has been authenticated for the authenticated card a, then the AP 1 accesses the card a. If the AP 1 has not been authenticated for the authenticated card a, then the AP 1 is notified of an error.

10) When one accessing process is completed and the card a is released, the AP 1 notifies the exclusion control mechanism 11 of the cancellation of the exclusive access.

11) The exclusion control mechanism 11 deletes the registered exclusive access to the card a by the AP 1, and registers the exclusive access of another application 21 if it is registered in the queue waiting for exclusive access to the card a.

12) After canceling the exclusive access, the AP 1 performs a process other than the accessing process to the card a. During the period, the cars a is released from the exclusive access. Therefore, another application 21 can use the card a.

13) The AP 1 requests the exclusion control mechanism 11 to allow the AP 1 exclusive access when it is necessary again to access the card a.

14) In response to the request from the AP 1, the exclusion control mechanism 11 checks again whether or not there is exclusive access to the card a as in the case 2) above. If another application has not been allowed exclusive access, the AP 1 is notified of the exclusive access.

15) The AP 1 requests the access control mechanism 12 to read/write data to the card a.

16) The access control mechanism 12 performs the process of 9) above. At this time, since it is registered in the authentication status management table that the AP 1 has been authenticated for the card a in 7) above, the AP 1 accesses the card a as is. Then, the processes of 10) through 16) are repeated the number of times of the accessing process to the card A in the AP 1.

17) When all accessing processes are completed, the AP 1 notifies the access control mechanism 12 of the cancellation of the authentication for the card a.

18) The access control mechanism 12 deletes the information about the authentication of the AP 1 for the card a in the authentication status management table.

19) The access control mechanism 12 holds the authentication status until no application 21 authenticated for the card a can be detected in an authentication status management table 13. When no application 21 authenticated for the card a can be detected in the table, the access control mechanism 12 requests the card a to cancel the authentication. Thus, times of the accessing process for the same smart card can be reduced.

20) The AP 1 notifies the access control mechanism 12 of the completion of the access to the smart card 22.

21) Upon receipt of the notification in 20) above, the access control mechanism 12 deletes the AP 1 from the authentication status management table. At this time, if the AP 1 has not completed the access to another smart card 22, then the AP 1 is not deleted from the authentication status management table.

22) The AP 1 notifies the exclusion control mechanism 11 of the cancellation of the exclusive access to the card a.

23) The exclusion control mechanism 11 performs the process similar to the process in 11) above, and the exclusive access is canceled.

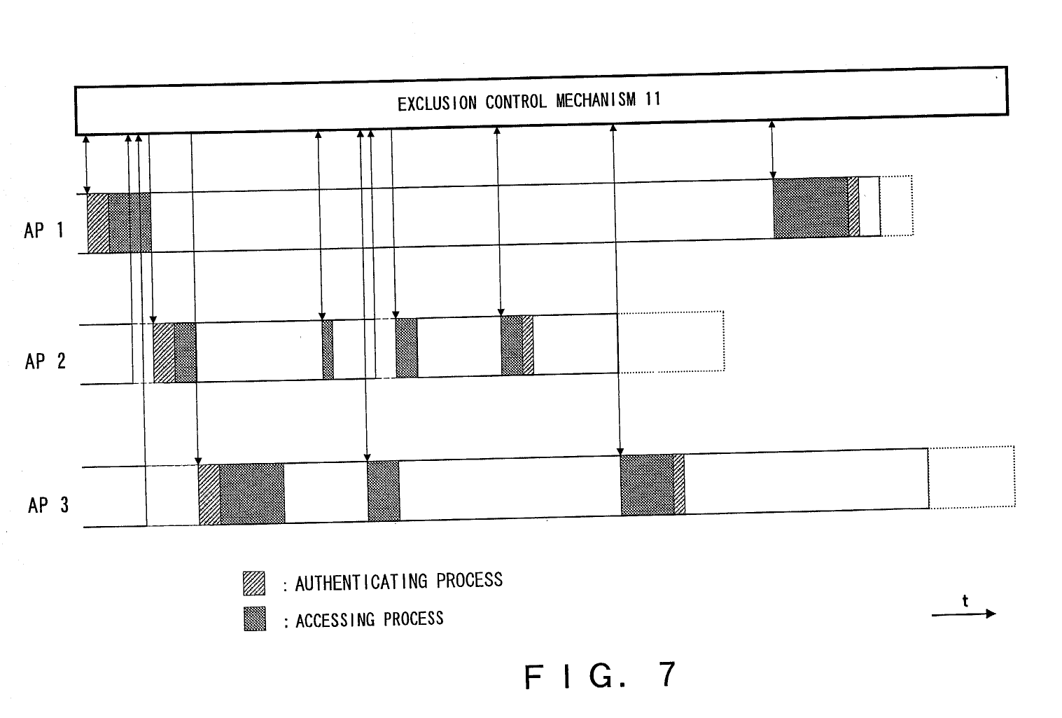

FIG. 7 shows the process performed by each application on a smart card with the configuration containing the exclusion control mechanism 11 and the access control mechanism 12 shown in FIG. 4.

FIG. 7 shows the process of the same application 21 based on the same conditions shown in FIG. 3 for correct comparison. In FIG. 7, as compared with FIG. 3, each application 21 performs the authenticating process using a PIN when the accessing process to the first card a is started, and the authentication canceling process for the card a when the last accessing process is completed. However, the authenticating process performed as shown in FIG. 3 for each accessing process to the card a is omitted. Therefore, the processing time required for each application 21 can be shortened by the time required for the omitted authenticating process. Since the period of each application 21 occupying the card a can also be shortened by the period of the omitted authenticating process, there is some possibility of shortening a period of the wait state. Furthermore, since each application 21 has to once perform an authenticating process using a PIN for the smart card 22, the application 21 can discard the PIN after obtaining authentication from the card.

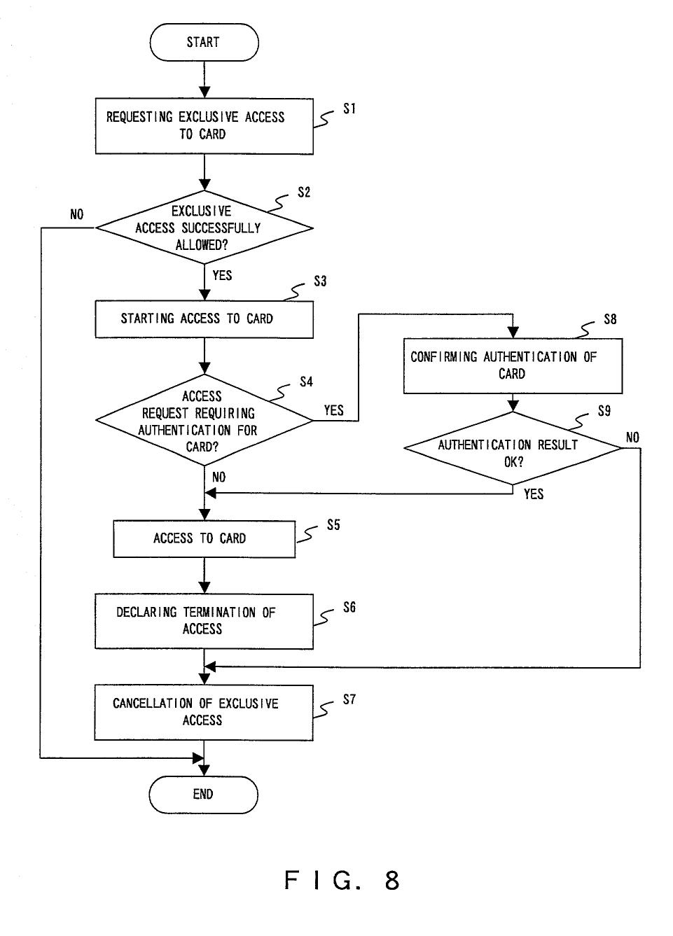

FIG. 8 is a flowchart of the process of the application 21 accessing the smart card 22 according to the present system.

The mechanism for performing the following processes can be configured in the application 21. However, the processes can normally be realized as a library, and the library can be incorporated into each application 21.

When the application 21 accesses the smart card 22, it first requests the exclusion control mechanism 11 to allow it exclusive access to the card (step S1), and waits for the response from the exclusion control mechanism 11. As a result, when the exclusion control mechanism 11 notifies the application 21 that the exclusive access cannot be allowed for any reason (NO in step S2), the process terminates.

If the exclusion control mechanism 11 notifies the application 21 of a successful exclusive access notification in response to the exclusive access request (YES in step S2), then in step S3 a declaration of the start of the access to the smart card 22 is issued to the access control mechanism 12.

If the smart card 22 to which access is gained is not authenticated, and if the access control mechanism 12 prompts the application to input a PIN to obtain authentication for the smart card 22 (YES in step S4), then the password inputted by the user as the PIN is transmitted to the access control mechanism 12 for an authenticating process. Then, the result is confirmed. If the authentication can be successfully obtained (YES in step S9), then control is passed to step S5, and the smart card is accessed. If the authentication cannot be successfully obtained (NO in step S9), then the process terminates.

When access is gained to the smart card 22 which has already been authenticated in step S4 (NO in step S4), a further authenticating process is not required. Therefore, access to the smart card 22 is allowed in step S5 to read/write data.

When the accessing process in step S5 is completed, a declaration of the completion of the access to the smart card 22 is issued to the access control mechanism 12 in step S6. Then, in step S7, the exclusion control mechanism 11 is notified of the cancellation of the exclusive access to the smart card 22, and the process of accessing the smart card 22 terminates.

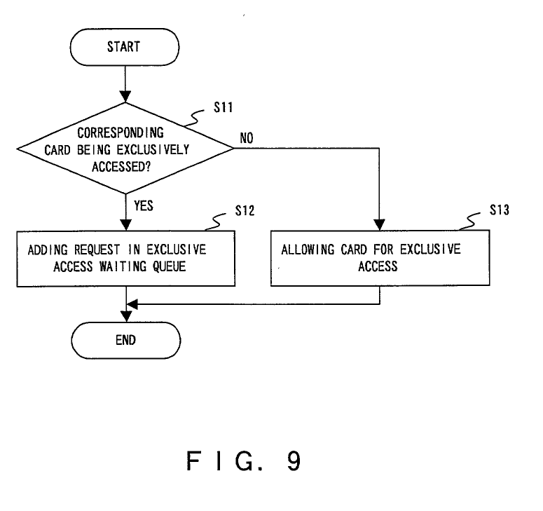

FIG. 9 is a flowchart of the process of the exclusion control mechanism 11 in response to the exclusive access request from the application 21.

Upon receipt of an exclusive access request to the smart card 22 from the application 21, the exclusion control mechanism 11 determines in step S11 whether or not the smart card 22 for which the exclusive access request has been issued has already been exclusively accessed by another application 21. As a result, if the smart card 22 has not been exclusively accessed by another application 21 (NO in step S11), it is registered that the smart card 22 has already been exclusively accessed, the requesting smart card 22 is notified of the exclusive access, and the process terminates.

If another application 21 has already been allowed exclusive access to the smart card 22 in step S11 (YES in step S11), then the exclusive access request is queued in step S12, and the process terminates.

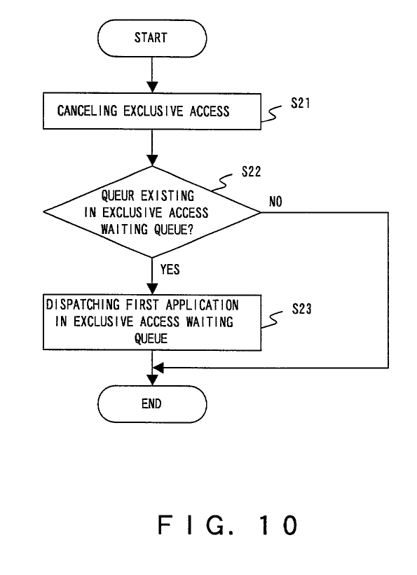

FIG. 10 is a flowchart of the process of the exclusion control mechanism 11 performed in response to an exclusive access cancellation notification from the application 21.

Upon receipt of the notification about the cancellation of exclusive access to the smart card 22 from the application 21, the exclusion control mechanism 11 deletes the registration that the application 21 has been allowed exclusive access in step S21, and then the exclusive access is canceled.

Then, the exclusive access waiting queue is checked. If there is any application 21 waiting for exclusive access to the smart card 22 for which exclusive access has been canceled (YES in step S22), then the exclusive access to the smart card 22 from the application 21 which is registered as the first application in the exclusive access waiting queue is registered, and the smart card 22 is dispatched in step 23, and the process terminates. At this time, if no application is in the exclusive access waiting queue (NO in step S22), the process terminates.

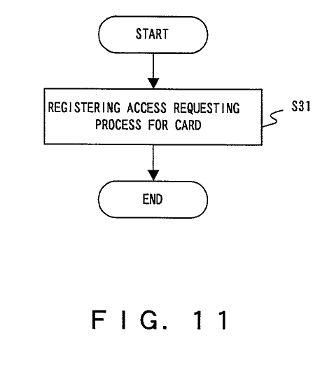

FIG. 11 is a flowchart of the process of the access control mechanism 12 performed in response to an access request from the application 21 to the smart card 22.

In response to the declaration of the start of the access from the application 21, the access control mechanism 12 registers the application 21 in the authentication status management table, and registers an access request process for the smart card 22 in step S31.

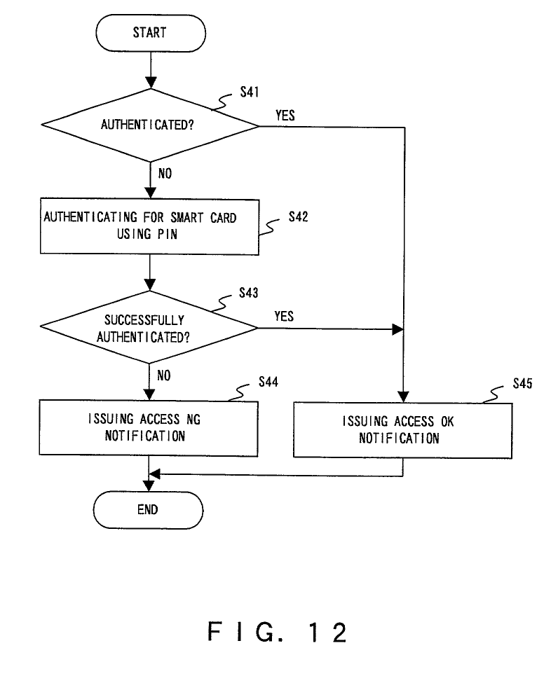

FIG. 12 is a flowchart of the process of the access control mechanism 12 performed in response to the access request from the application 21 to the smart card 22.

In response to the access request from the application 21, the access control mechanism 12 refers to the authentication status management table in step S41, and checks whether or not the application 21 has already been authenticated for the smart card 22 for which the application 21 has issued the access request. As a result, if it has already been authenticated (YES in step S41), no further authentication is required, thereby notifying the application 21 of the access permission in step S45.

If the application 21 has not been authenticated in step S41 (NO in step S41), then it is necessary to perform an authenticating process. Therefore, in step S42, the application 21 is prompted to input a password, and it is requested that the authenticating process is performed for the smart card 22 using a PIN. If the authentication for the smart card 22 can be obtained, then the application 21 is allowed access in step S45. If the authentication cannot be allowed (NO in step S43), then the application 21 is notified of an access rejection notification, thereby terminating the process.

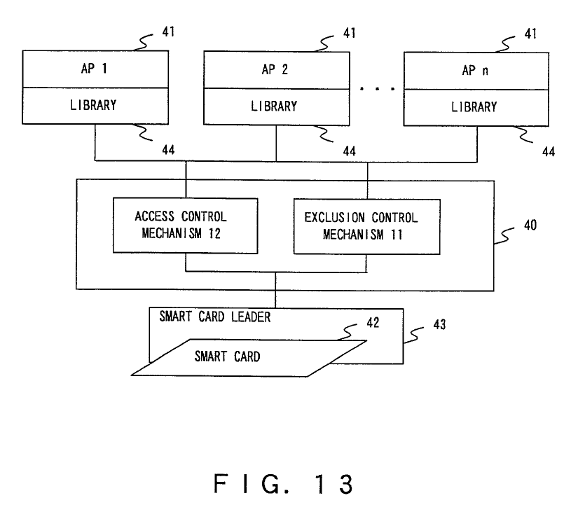

FIG. 13 shows the configuration of the system using a smart card according to the present embodiment.

An access management system 40 for management between an application 41 and a smart card 42 according to the present embodiment is provided between a smart card leader 43 and a library 44 of each application 41, and is realized as the installation as a function of an OS or in the OS.

The application 41 performs the authenticating process and an accessing process on the smart card 42 through the access management system 40. The access management system 40 grasps the transmission and reception of data between each application 41 and the smart card 42. Furthermore, the access management system 40 grasps the status of the smart card leader 43. For example, when the smart card 42 is extracted from the smart card leader 43, the authentication status management table is checked. If there is any application already authenticated for the card, it is changed as being non-authenticated.

Although the access management system 40 is configured as having the exclusion control mechanism 11 and the access control mechanism 12 separately inside the system, they can be realized as one function component. Additionally, for increased security, it is necessary that an access control mechanism and an exclusion control mechanism can be shared by a plurality of applications. Therefore, if they are realized in the kernel of an OS, the security can be furthermore improved.

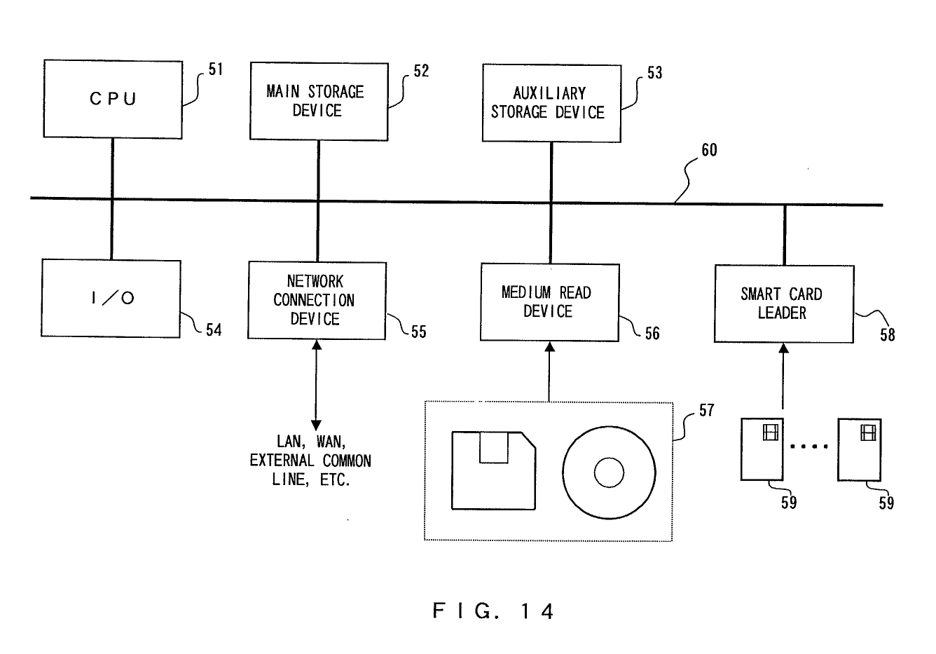

FIG. 14 shows the system environment of the information processing device when the above mentioned smart card access management according to an embodiment of the present invention is realized by a computer program.

An information processing device using a smart card comprises, as shown in FIG. 14, a CPU 51, a main storage device 52 including ROM and RAM, an auxiliary storage device 53, an input/output device (I/O) 54 such as a display, a keyboard, etc., a LAN, a WAN, a network connection device 55 such as a modem, etc. for network connection to another information processing device through a common line, etc., a medium read device 56 for reading stored contents from a portable storage medium 57 such as a disk, a magnetic tape, etc., and a smart card leader 58 containing one or more smart cards 59. These components are connected through a bus 60.

In the information processing system shown in FIG. 14, the medium read device 56 reads a program and data stored in the portable storage medium 57 such as a magnetic tape, a floppy disk, CD-ROM, MO, etc., and downloads them onto the main storage device 52 or the hard disk 55. Each process according to the present embodiment can be realized as software by the CPU 51 executing the program and the data.

In this information processing device, application software can be exchanged using the portable storage medium 57 such as a floppy disk, etc. Therefore, the present invention is not limited to the smart card access management system or sharing method, but can be configured as a computer-readable storage medium 57 used to direct a computer to perform the function according to the embodiment of the present invention.

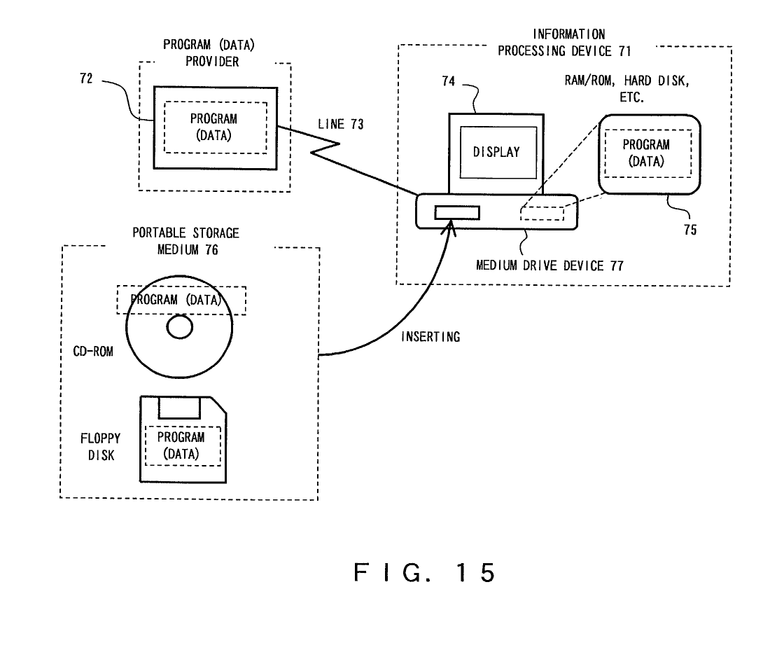

In this case, a storage medium can be, for example, as shown in FIG. 15, a portable storage medium 76 removable from a medium drive device 77 such as CD-ROM, a floppy disk (or MO, DVD, a removable hard disk, etc.), etc., a storage unit (database, etc.) 72 in an external device (server, etc.) transmitted through a network line 73, memory (RAM or a hard disk, etc.) 75, etc. in a body 74 of an information processing device 71. A program stored in the portable storage medium 76 and the storage unit (database, etc.) 72 is loaded onto the memory (RAM, hard disk, etc.) 75 in the body 74, and executed.

As described above, according to the present invention, since the exclusion control is performed on a smart card by an exclusion control mechanism, each application is authenticated although a plurality of applications share a smart card.

In addition, since the authentication between each application and a smart card is centrally managed, it is determined whether or not an application has been authenticated for a smart card when the application issues a request to access the smart card, and an authenticating process is performed only when it has not been authenticated, thereby reducing the times of the authenticating processes, and also reducing the overhead from the authenticating process. In addition, since the authenticating process using a PIN is once performed at first, it is not necessary for an application to keep holding a PIN, and the security level can be enhanced.

Furthermore, a smart card can be accessed among a plurality of authenticated applications with the authentication status held as is.

In addition, the waiting period of an application for exclusive access can be shortened. Therefore, the parallelism of processes can be improved, and the processing time of each application can be shortened.

What is claimed is:

1. An access management system managing access to a smart card by a plurality of applications, comprising:
an exclusion control unit allowing an application exclusive access to a smart card, in response to an exclusive access request for the smart card from the application, when the smart card has a logical channel not exclusively accessed by another application; and
an access control unit permitting the application allowed the exclusive access to access the smart card, in response to an access request for the smart card from the application, when the application has already been authenticated for the smart card.

2. The system according to claim 1, wherein
said exclusion control unit queues an application which issues an exclusive access request in response to an exclusive access request for the smart card from the application when the smart card has no logical channel not exclusively accessed by another application.

3. The system according to claim 1, wherein
said access control unit rejects the access request from the application allowed the exclusive access if the application has not been authenticated for the smart card.

4. The system according to claim 1, wherein
said access control unit manages authentication between an application and a smart card using a process ID of the application.

5. The system according to claim 1, wherein
said access control unit changes an application authenticated for a smart card into a non-authenticated application when the smart card is extracted from a smart card reader.

6. The system according to claim 1, wherein
when said application accesses the smart card plural times, said application issues the exclusive access request to said exclusion control unit each time the access is started, and issues an exclusive access cancellation notification to said exclusion control unit each time the access terminates.

7. The system according to claim 6, wherein
said exclusion control unit queues an application which issues an exclusive access request for a smart card if the smart card has already been exclusively accessed by another application, and allows the queued application exclusive access upon receipt of the exclusive access cancellation notification from the application which has exclusively accessed the smart card.

8. The system according to claim 1, wherein
said access control unit request a smart card to cancel authentication of an application, in response to a smart card authentication cancellation notification from the application, when the application is the last application authenticated for the smart card.

9. An access management system managing access to a smart card by a plurality of applications, comprising:
exclusion control means for allowing an application exclusive access to a smart card, in response to an exclusive access request for the smart card from the application, when the smart card has a logical channel not exclusively accessed by another application; and
access control means for permitting the application allowed the exclusive access to access the smart card, in response to an access request for the smart card from the application, when the application has already been authenticated for the smart card.

10. A method for sharing a smart card and managing access to the smart card by a plurality of applications, comprising:
allowing an application exclusive access to a smart card, in response to an exclusive access request for the smart card from the application, when the smart card has a logical channel not exclusively accessed by another application; and
permitting the application allowed the exclusive access to access the smart card, in response to an access request for the smart card from the application allowed the exclusive access, when the application allowed the exclusive access has already been authenticated for the smart card.

11. An application including a plurality of accessing processes to one smart card, wherein:
an exclusive access request is issued for each accessing process each time the accessing process is started, and an exclusive access cancellation notification is issued each time each accessing process terminates; and
an authentication request is issued for a smart card to be accessed only in a first accessing process in said plurality of accessing processes.

12. A library of an application including a plurality of accessing processes to one smart card, wherein:
an exclusive access request is issued for each accessing process each time the accessing process is started, and an exclusive access cancellation notification is issued each time each accessing process terminates; and
an authentication request is issued for a smart card to be accessed only in a first accessing process in said plurality of accessing processes.

13. A storage medium readable by an information processing device, in which a plurality of applications are operated in parallel, storing a program used to direct the information processing device to perform the processes of:
allowing an application exclusive access to a smart card, in response to an exclusive access request for the smart card from the application, when the smart card has a logical channel not exclusively accessed by another application; and
permitting the application allowed the exclusive access to access the smart card, in response to an access request for the smart card from the application, when the application has already been authenticated for the smart card.
